(19) United States
(12) Patent Application Publication
(10) Pub. No.: US 2013/0160409 A1
(43) Pub. Date: Jun. 27, 2013

(54) ANIMAL HALTER

(71) Applicant: Edward Michael Crothers, West Union, OH (US)

(72) Inventor: Edward Michael Crothers, West Union, OH (US)

(21) Appl. No.: 13/722,209

(22) Filed: Dec. 20, 2012

Related U.S. Application Data
(60) Provisional application No. 61/578,310, filed on Dec. 21, 2011.

(51) Int. Cl. B68B 1/02

(52) U.S. Cl. CPC B68B 1/02
USPC 54/24

(57) ABSTRACT

The animal halter comprises a nose band sized to encircle the nose of the animal. The band has a top that aligns with the bridge of the nose of the animal, a bottom under the chin of the animal, and a left and right side. The nose band has one or more pressure protrusions. A crown-throat loop has one or more pressure protrusions and an optional brow band. The brow band may also have one or more pressure protrusions. The crown-throat loop has a top that aligns with the poll of the head of the animal, a bottom and a left and right side. A right cheek strap and a left cheek strap connect the sides of the nose band and the crown-throat loop. A chin-throat connecting piece connects the bottoms of the nose band and the crown-throat loop.

### PRIORITY

This application claims priority to U.S. Provisional Patent Application Ser. No. 61/578,310, filed Dec. 21, 2011, entitled “Animal Halter,” the disclosure of which is incorporated by reference herein.

### FIELD OF THE INVENTION

The present invention relates to an animal halter. More particularly, the halter is constructed to provide an improved level of control of the animal by providing specific, multi-directional pressure contact points around the animal's head that allows the handler to more efficiently communicate his or her desires to the animal.

### BACKGROUND

Halters are used to enable animal owners, trainers and handlers to hold, control and lead their animals. Halters may be used with any animals, including horses, cattle or other livestock, zebras, dogs, etc. Improved control over the animal provides improved safety of the handler and others around the animal. Improved communication with the animal provides more efficient training, and therefore a quicker time to train the animal. Many different styles of halters have been utilized in the past for training procedures. Halters are generally bitless and make use of two loops; one extending around the nose of the animal and the other extending either around the neck or around from the poll to the chin groove and back.

Regardless of the configuration of traditional halters, halters are designed to allow the handlers to apply a downward pressure to the poll of the head, the neck, and/or the bridge of the nose. These traditional halters only provide this downward pressure which sends only a “stop” message to the animal. Traditional halters do not provide efficient directional messages. Also, since the straps of the halters are generally made of flat strips of leather or woven nylon, the applied downward force is generally a diffuse pressure applied across a fairly broad contact surface area at the poll or the nose.

Often such a diffuse applied pressure is insufficient to control a more head-strong animal. As a result, the handler feels he or she must apply more and more pressure, until a maximum amount of pressure is being applied or the handler reverts to a hard jerking motion on the animal's head to control it. However, such extreme pressure or motions rarely delivers an understandable message to the animal. The result is often a frustrated animal and trainer.

Many attempts have been made to provide halters with additional control. U.S. Pat. No. 3,949,538, for example, provided a rope or cable halter having a first loop around the head and a second loop around the nose, with knot protuberances in both loops selectively located to provide discomforting pressure directly to facial nerves around the horse's head when the halter, specifically the loops, are contracted around the head by a pulling force on the reins of the halter. Knots in the first loop apply discomforting pressure to facial nerves at the top of the head, including the great auricular nerve and the second cervical nerve. Knots in the second loop apply discomforting pressure to the infraorbital nerve and dorsal buccal nerves at the respective sides of the nose. All this does is provides contraction, painful pressure to the head of the animal. Since the halter acts by contraction of all of the halter components equally, there is no directional message sent while using this halter.

While a variety of animal halters have been made and used, it is believed that no one prior to the inventor has made or used an invention as described herein.

### SUMMARY OF THE INVENTION

The present invention relates to an animal halter comprising a nose band configured to encircle the nose of an animal, the nose band having a top that aligns with the bridge of the nose of the animal and a bottom portion operable to be positionable under the chin of the animal, wherein the nose band comprises at least one pressure protrusion; a left strap portion in communication with the nose band, wherein the left strap portion is configured to be positionable to the left of the nose of the animal; a right strap portion in communication with the nose band, wherein the right strap portion is configured to be positionable to the right of the nose of the animal; a crown-throat loop sized to encircle the head of the animal at the poll, the crown-throat loop having a top portion configured to align with the poll of the head of the animal, wherein the right strap portion and the left strap portion are configured to separately connect the nose band and the crown-throat loop; and a chin-throat connecting portion configured to provide communication between the bottom portion of the nose band and the crown-throat loop.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 depicts a side elevation view of an exemplary placement of an exemplary animal halter on a horse head;

FIG. 2 depicts a side, pictorial view of the animal halter referred to in FIG. 1;

FIG. 3 depicts a top, plan view of one of one exemplary pressure protrusion nodules in a strap of the animal halter of FIG. 2;

FIG. 4 depicts a side, elevation view of the pressure protrusion nodule and the strap of FIG. 3;

FIG. 5 depicts a side, cross sectional view of the pressure protrusion nodule and the strap of FIG. 3;

FIG. 6 depicts a side, cross sectional view of an alternative version of a strap.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description. As will be realized, the invention is capable of other different and obvious aspects, all without departing from the invention. Accordingly, the drawings and descriptions should be regarded as illustrative in nature and not restrictive.

It will be appreciated that the exemplary version of an animal halter described below may be used generally with horses. Though, it is contemplated that the animal halter may be used with a variety of animals including zebras, other livestock such as cattle, dogs or other animals smaller than horses, animals larger than horses, or any other suitable animal as would be apparent to one of ordinary skill in the art in view of the teachings herein.

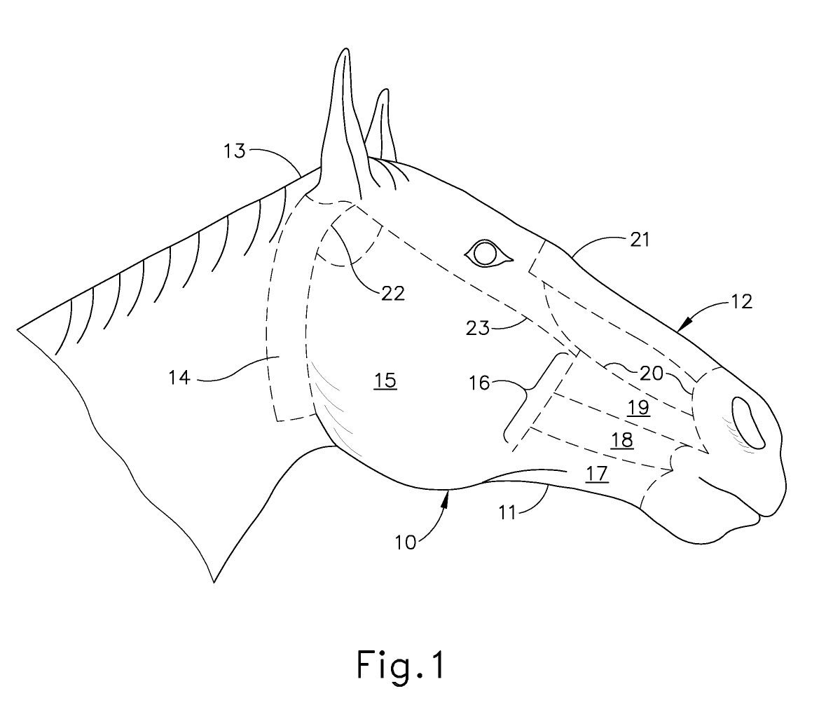

FIG. 1 illustrates the general anatomy of the head 10 of a horse. The head 10 includes the poll region 13 adjacent to the ears, parotid regions 14 ventral to the ears, the masseteric regions 15, and the posterior end of the chin groove 11 adjacent to the masseteric regions 15. The nose 12 includes the cheek regions 16, the lateral regions 20, and the bridge 21. The cheek regions 16 may be broken down into three subregions, each comprising the mandibular subregion 17, the molar subregion 18, and the maxillary subregion 19. The head 10 also comprises a cheek crest 23 extending along the head from the ears to the cheek regions 16.

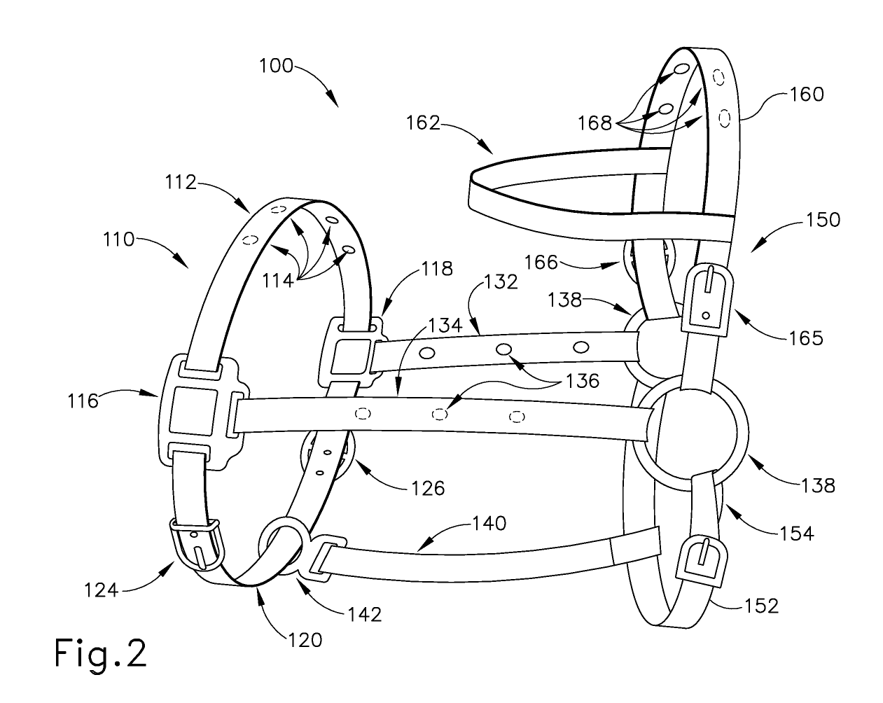

An exemplary animal halter 100 is shown in FIG. 2. The halter 100 may be constructed out of leather, woven nylon, rope, cable or other flexible material. The exemplary versions of the halter 100 are constructed out of leather or nylon, though any suitable material may be used as would be apparent to one of ordinary skill in the art in view of the teachings herein. The halter 100 comprises a nose band 110, a crown-throat loop 150, and three straps: a right strap 132, a left cheek strap 134 and a chin-throat connecting strap 140. Each of the right strap 132 and the left cheek strap 134 have one end fastened to the right and left sides, respectfully, of the nose band 110 and a second end fastened to the right and left sides, respectfully, of the crown-throat loop 150. The chin-throat connnecting strap 140 has one end fastened at the bottom of the nose band 110 and a second end fastened to the bottom of the crown-throat loop 150. Thus the three straps connect the nose band 110 to the crown-throat loop 150 to hold the halter 100 together. While the exemplary version uses three straps to hold the halter 100 together, it will be understood that any suitable number including more or less straps may be used as would be apparent to one of ordinary skill in the art in view of the teachings herein.

The nose band 110 comprises one or more pressure protrusions 114, and the crown-throat loop 150 also comprises one or more pressure protrusions 168. Furthermore, the right cheek strap 132 and the left cheek strap 134 comprise one or more pressure protrusions 136. In certain versions of the halter 100, each of the nose band 110, the crown-throat loop 150, the right cheek strap 132, and the left cheek strap 134 comprise one or more pressure protrusions 114, 136, and 168. It will be understood that even though the exemplary version shows the nose band 110, the crown-throat loop 150, the right cheek strap 132, and the left cheek strap 134 as all having the one or more pressure protrusions 114, 136, 168, in some exemplary versions, only the nose band 110 may have pressure protrusions 114, or only the crown-throat loop 150 may have pressure protrusions 168, or only the right cheek strap 132 and/or the left cheek strap 134 may have pressure protrusions 136. It will be understood that when the halter 100 is placed on an animal such as a horse, the pressure protrusions 114, 136, 168 extend towards the horse such that the pressure protrusions 114, 136, 168 remain in substantial contact with the horse. In the exemplary version, it will be understood that the pressure protrusions 114, 136, 168 on the pieces of the halter 100 work either alone or together to better communicate the instructions from the handler to the animal.

The halter 100 is generally used in conjunction with a rope or strap, or “lead-rope” connected to the bottom of the nose band 110 under the chin of the animal. When utilizing the halter 100, the handler can provide instructions to the animal by simple and gentle hand movements on the lead-rope to pull either the top of the nose band 110 or the top of the crown-throat loop 150 into tighter contact with the hair or skin of the animal. The protrusions 114 or 168 provide focused contact points to the touch sensitive hair and skin of the animal's head to deliver instructive messages to the animal. The protrusions 114 at the top of the nose band 110 provide a touch contact in a downward direction to the bridge of the nose 21 when the handler moves the lead-rope backward or down. This downward touch contact provides a “stop” message to the animal. The protrusion 168 at the top of the crown-throat loop 150 provides a touch contact in a forward direction to the poll region of the head 13 when the handler moves the lead-rope forward. This touch contact is operable to provide a “move forward” message to the animal.

In the versions of the halter 100 which have protrusions 136 in the left and right cheek straps 132 and 134, the handler may also provide a left and right touch contact to the animal by simple movement of a lead-rope to the left or right. With the use of this version of the halter 100, the handler is easily able to convey his/her choice of a “stop” message, a “move forward” message, or a “move left” or “move right” message to the animal by simple movements of the lead-rope.

The nose band 110 is sized to encircle the nose 12 of the animal, has a top that aligns with the bridge 21 of the nose of the animal, a bottom under the chin of the animal, and a left and right side. The nose band 110 of the halter 100 has one or more pressure protrusions 114 along the inside of the nose band 110. The protrusions 114 are generally solid smooth nodules raised from the inside surface of the band material. The protrusions 114 are spaced along the inside surface of the top of the nose band 110 to provide contact pressure to hair and skin of the bridge 21 of the nose. The protrusions 114 are smooth so the pressure applied by the protrusions 114 is focused, but not painful or sharp in the skin of the animal's nose. Instead of painful or sharp digging signals to the animal, it is understood that the protrusions 114 of the halter 100 provide an unfamiliar contact touch to the sensitive hair and skin of the animal. It will be appreciated the halter 100 in the exemplary configuration may provide additional control and better training of the animal.

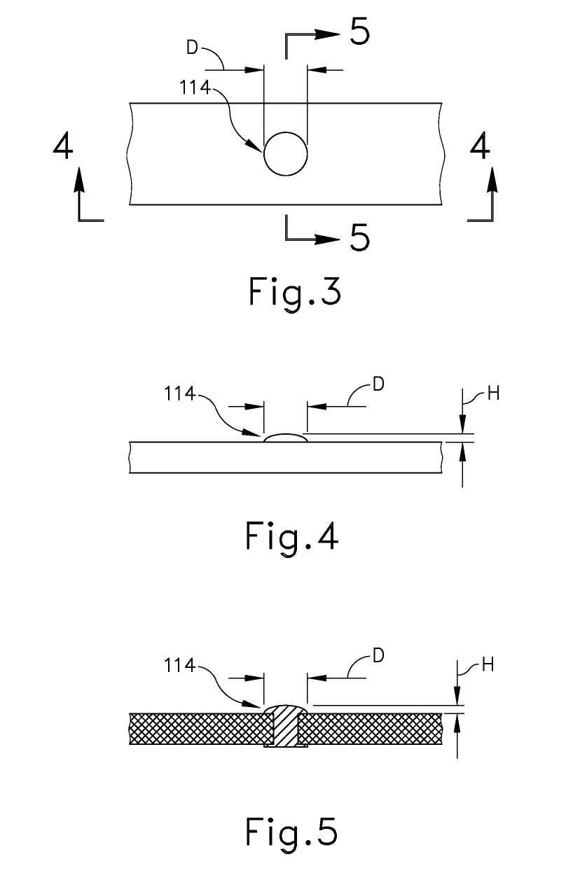

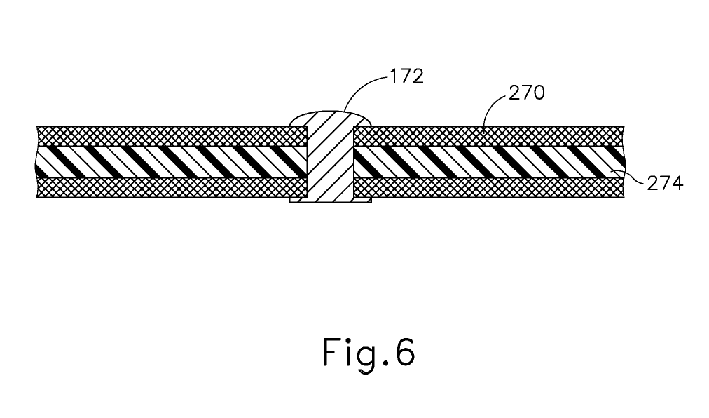

The nodules which may form the protrusions 114 on the straps of the halter 100 may be made out of metal, plastic, or other solid material. The nodules are generally formed to provide a curved, but smooth, contact with the hard honey surface of the bridge of the nose. FIGS. 3-4 shows an exemplary protrustion 172 which may be any suitable top-view shape, but generally are circular with a diameter, D, of from about 0.125 inch to about 1 inch. Protrusion 172 may represent or may be substantially similar to any of the protrusions 114, 136, or 168. The protrusion 172 extends above the inner surface of the strap 170 to a height, H, in any shape profile. Strap 170 may represent any strap portion of halter 100 as described above including, but not limited to, the nose band 110, the left and right cheek straps 132 and 134, and/or the crown-throat loop 150. In some embodiments, the protrusions 172 have a curved profile. The protrusions 172 have a maximum height, H, above the surface of the band material from about 0.0625 inch to about 0.375 inch. Some versions have protrusions 172 with a circular top-view with a diameter, D, of from about 0.1875 inch to about 0.375 inch and a curved side profile with maximum height, H, of about 0.0675 inch to about 0.125 inch, though it will be understood that smaller and larger dimensions for D and H may be used as would be apparent to one of ordinary skill in the art in view of the teachings herein. One version of the protrusion 172 may be provided by a rivet as shown in FIG. 5. In particular, the protrusion 172 may extend through the strap 170 where the strap 170 comprises any suitable solid, yet flexible material. In some versions, for instance, as seen in FIG. 6, the protrusion 172 may extend through a layered material such as the layered strap 270 where a plastic, vinyl, or any other suitable middle layer 274 may extend through the center of the strap 270 such that the protrusion 172 extends through the strap 270 including the middle layer 274. The strap 270 layer may comprise, for instance, a nylon material, though it will be understood that any suitable flexible material may be used. It will be understood that the middle layer 274 may be operable to stabilize the protrusion 172 within the strap 270. In particular, the protrusion 172 may be anchored in the middle layer 274 and extend through the strap 270 as seen in FIG. 6. Though it will be understood that the protrusion 172 need not necessarily be used with the middle layer 274.

The nose band 110 may comprise a single band of material with its ends fastened, by for example sewing, to form the circular band. Other versions might use a buckle or other suitable fastener to connect the ends of the nose band 110. In yet other versions, an example shown in FIG. 2, the nose band 110 may comprise an upper band 112 fastened at each end to left and right nose attachment rings 116 and 118, and a chin strap 120 also fastened at each end to the left and right nose attachment rings 116 and 118. The chin strap 120 may comprise a single strap of material or may comprise two, three, or any suitable number of pieces connected by chin buckles, used to tighten the nose band 110. FIG. 2 shows a three piece chin strap connected to the left and right nose attachment rings 116 and 118 and connected by a left and right chin buckle 124 and 126.

The crown-throat loop 150 forms a circular band sized to fit around the top end of the animal's head around the poll 13 of the head and throat of the horse. The crown-throat loop 150 also comprises one or more pressure protrusions 168 similar to the nose band protrusions 114 spaced along the top of the crown-throat loop 150. The protrusions 168 along the top of the band are operable to provide touch contact to the hair and skin on boney surfaces at the poll of the animal's head. The crown-throat loop protrusions 168 may have the same or different design than the nose band protrusions 114, but may also have the same general characteristics. In the exemplary version, protrusions 114, 136, and 168 are generally equally spaced apart along their respective straps, but it will be understood that any suitable spacing may be used. For instance a high concentration of protrusions 114, 136, and 168 may be located in one portion of the strap, whereas fewer protrusions 114, 136, and 168 may be used in another portion.

The crown-throat loop 150 may comprise a single band of material with ends fastened to form a generally circular band. Other versions of the crown-throat loop 150 may comprise a one, two, three or more piece crown piece 160 comprising the pressure protrusions 168, and a throat latch 152. The crown piece 160 may comprise an optional brow band 162. FIG. 2 shows a halter 100 with a crown-throat loop 150 with a three piece crown piece 160 with the ends of the crown piece 160 with ends fastened to left and right cheek rings 138 and 139, and internally fastened with left and right crown buckles 165 and 166. The crown piece 160 is shown with the brow band 162. The crown-throat loop 150 also comprises a throat latch 152 fastened at one end to one of the cheek rings 138 or 139 (the right cheek ring in FIG. 2) and having a clasp 154 for releasable fastening to the other cheek ring.

The right cheek strap 132 and the left cheek strap 134, each strap optionally having one or more pressure protrusions 136, are respectively connected to the respective sides of the nose band 110 and the crown-throat loop 150. The chin-throat connecting piece 140 is connected to the bottoms of the nose band 110 and the crown-throat loop 150. Some versions of the halter 100, shown in FIG. 2, have one end of the right and left cheek straps 132 and 134 fastened to the left and right nose attachment rings 116 and 118, and the other end fastened to the left and right cheek rings 138 and 139. Also, one end of the chin-throat connecting piece 140 is permanently affixed (though may also be releaseably affixed) to the bottom of the throat latch 152 of the crown-throat loop 150 and the other end is attached to a lead line ring 142 flexibly affixed to the chin strap 120 of the nose band 110.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

It should be understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

I claim:

1. An animal halter comprising:
(a) a nose band configured to encircle the nose of an animal, the nose band having a top that aligns with the bridge of the nose of the animal and a bottom portion operable to be positionable under the chin of the animal, wherein the nose band comprises at least one pressure protrusion;
(b) a left strap portion in communication with the nose band, wherein the left strap portion is configured to be positionable to the left of the nose of the animal;
(c) a right strap portion in communication with the nose band, wherein the right strap portion is configured to be positionable to the right of the nose of the animal;
(d) a crown-throat loop sized to encircle the head of the animal at the poll, the crown-throat loop having a top portion configured to align with the poll of the head of the animal, wherein the right strap portion and the left strap portion are configured to separately connect the nose band and the crown-throat loop; and
(e) a chin-throat connecting portion configured to provide communication between the bottom portion of the nose band and the crown-throat loop.

2. The halter of claim 1, wherein the nose band comprises a plurality of nose band pressure protrusions spaced along the nose band, wherein the crown-throat loop a plurality of crown-throat pressure protrusions spaced along the crown-throat.

3. The halter of claim 2, wherein the nose band comprises 3, 4, or 5 nose band pressure protrusions, wherein the crown-throat loop comprises 3, 4, or 5 crown-throat pressure protrusions.

4. The halter of claim 1, wherein the right cheek strap and the left cheek strap each comprise at least one pressure protrusion.

5. The halter of claim 4, wherein the right cheek strap comprises 3, 4, or 5 pressure protrusions, wherein the left cheek strap comprises 3, 4, or 5 pressure protrusions.

6. The halter of claim 1, wherein at least one protrusion has a top view circular shape with a diameter of about 0.125 inch to about 1 inch, wherein the at least one protrusion has a curved side view profile shape with a maximum height from the inner surface of the respective portion of the halter of from about 0.0625 inch to about 0.375 inch.

7. The halter of claim 1, wherein the nose band comprises an upper band fastened at one end to a left nose attachment ring and the other end to a right nose attachment ring, wherein a chin strap is fastened at one end to the left nose attachment ring and the other end to the right nose attachment ring.

8. The halter of claim 1, wherein the nose band comprises a crown piece with one end fastened to a left cheek ring, wherein the other end is fastened to a right cheek ring, wherein the nose band further comprises a throat latch also having one end fastened to the left cheek ring and the other end fastened to the right cheek ring.

9. The halter of claim 8, wherein the crown piece comprises a brow band.

10. The halter of claim 1, wherein the nose band is dimensioned to fit a horse, wherein the crown-throat loop is dimensioned to fit a horse.

11. An apparatus comprising:
(a) a crown-throat loop configured to cover at least a portion of an animal's head, wherein the crown-throat loop;
(b) one or more cheek straps in communication with the crown-throat loop, wherein the one or more cheek straps extend distally from the crown-throat loop;
(c) a nose band in communication with the one or more cheek straps; and
(d) a plurality of protrusions, wherein a portion of the protrusions are configured to extend through a portion of the crown-throat loop, wherein another portion of the protrusions are configured to extend through a portion of the nose band.

12. The apparatus of claim 11, wherein yet another portion of the protrusions are configured to extend through a portion of the one or more cheek straps.

13. The apparatus of claim 11, wherein the one or more cheek straps comprises a left cheek strap and a right cheek strap.

14. The apparatus of claim 11, wherein the plurality of protrusions have a curved profile.

15. The apparatus of claim 11, wherein the portion of the plurality of protrusions extending through the nose band are configured to extend outward from the nose band from about 0.0625 inch to about 0.375 inch.

16. The apparatus of claim 11, wherein each of the plurality of protrusions have a diameter of about 0.125 inch to 1 inch.

17. The apparatus of claim 11, further comprising a chin strap in communication with the nose band, wherein the chin strap is in communication with the nose band through one or more nose attachment rings, wherein the chin strap is configured to tighten the nose band.

18. An apparatus comprising:
(a) a nose band comprising a nose band strap having one or more nose band protrusions extending through a portion of the nose band strap, wherein the nose band strap comprises an outer layer and an inner layer;
(b) a left cheek strap in communication with the nose band;
(c) a right cheek strap in communication with the nose band;
(d) a crown-throat loop, in communication with the left cheek strap and the right cheek strap, wherein the crown-throat loop comprises one or more crown-throat loop protrusions.

19. The apparatus of claim 18, wherein the left cheek strap comprises one or more left cheek strap protrusions, wherein the right cheek strap comprises one or more right cheek strap protrusions.

20. The apparatus of claim 18, wherein the nose band strap comprises a first layer and a second layer, wherein the one or more nose band protrusions extend through the first layer.
